(19) United States
(12) Patent Application Publication
(10) Pub. No.: US 2011/0237715 A1
(43) Pub. Date: Sep. 29, 2011

(54) FLAME RETARDANT COMPOSITIONS OF PHOSPHINIC ACID SALTS AND NITROXYL DERIVATIVES

(75) Inventor: Rainer Xalter, Basel (CH)

(73) Assignee: BASF SE, LUDWIGSHAFEN (DE)

(21) Appl. No.: 13/071,599

(22) Filed: Mar. 25, 2011

Related U.S. Application Data
(60) Provisional application No. 61/317,310, filed on Mar. 25, 2010.

(51) Int. Cl. C08K 5/3435; C08K 5/5313; C09K 21/10; C08K 5/3492

(52) U.S. Cl. 524/100; 524/99; 252/609

(57) ABSTRACT

The present invention relates to flame retardant polymer compositions which comprise mixtures of salts of phosphinic acids and 2,2,6,6-tetraalkylpiperidines. The mixtures are especially useful for the manufacture of flame retardant compositions based on thermoplastic polymers.

This application claims benefit of U.S. app. No. 61/317,310, filed Mar. 25, 2010, the contents of which are incorporated by reference.

The present invention relates to flame retardant polymer compositions which comprise phosphinic acid salts in combination with so-called sterically hindered nitroxyl derivatives. The compositions are especially useful for the manufacture of flame retardant compositions based on thermoplastic polymers, especially polyolefin homo- and copolymers and copolymers with vinyl monomers.

Flame retardants are added to polymeric materials (synthetic or natural) to enhance the flame retardant properties of the polymers. Depending on their composition, flame retardants may act in the solid, liquid or gas phase either chemically, e.g. as a spumescent by liberation of nitrogen, and/or physically, e.g. by producing a foam coverage. Flame retardants interfere during a particular stage of the combustion process, e.g. during heating, decomposition, ignition or flame spread.

There is still a need for flame retardant compositions with improved properties that can be used in different polymer substrates. Increased standards with regard to safety and environmental requirements result in stricter regulations. Particularly known halogen containing flame retardants no longer match all necessary requirements. Therefore, halogen free flame retardants are preferred, particularly in view of their better performance in terms of smoke density associated with fire. Improved thermal stability and less corrosive behaviour are further benefits of halogen free flame retardant compositions.

It has surprisingly been found that polymer compositions with excellent flame retardant properties are prepared in the event that phosphinic acid salts in combination with so-called sterically hindered amines are added to the polymer substrate.

Further benefits of the compositions of the present invention are improved electrical properties (CTI=comparative tracking index) and improved light stability compared to the use of halogenated FR system. Additionally, the flame retardant compositions are resistant to so-called leaching. The contact with water does not diminish their flame retardant activity.

It has surprisingly been found that by use of the flame retardant compositions according to the invention halogen containing flame retardants, such as decabromodiphenyl oxide, antimony compounds, and fillers may largely be reduced or replaced.

The invention relates to a composition, particularly a flame retardant composition, which comprises
a) A salt of a phosphinic acid as represented by the structural formulae

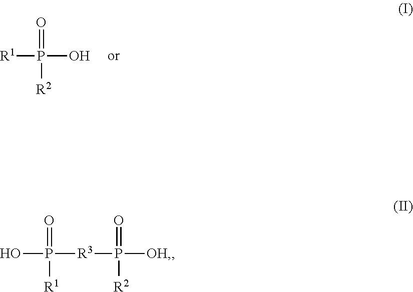

In which
one of R¹ and R² represents hydrogen or C₁-C₈alkyl; or both R¹ and R² represent C₁-C₈alkyl; and
R³ represents C₁-C₁₀alkylene, C₂-C₁₀alkylene interrupted by phenylene, phenylene, (C₁-C₄alkyl)₁₋₃phenylene, or phenyl-C₁-C₄alkylene;
b) A tetraalkylpiperidine or tetraalkylpiperazine derivative selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines, 1-acyloxy-2,2,6,6-piperidines, 1-hydroxy-2,2,6,6-tetraalkylpiperazines, 1-alkoxy-2,2,6,6-tetraalkylpiperazines, and 1-acyloxy-2,2,6,6-piperazines; and
c) A polymer substrate.

The composition defined above for use as a flame retardant is another embodiment of the invention.

A preferred embodiment of the invention relates to a composition, particularly a flame retardant composition, which comprises
a) The aluminium salt of diethylphosphinic acid (I), as represented by the formula

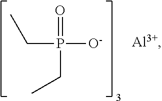

b) A tetraalkylpiperidine derivative selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines and 1-acyloxy-2,2,6,6-piperidines; and
c) A thermoplastic polymer substrate.

The compositions according to the invention exhibit excellent flame retardant properties at low concentrations of the components a) and b). Dependent on the concentrations of components a) and b) in the polymer substrate, V-2 ratings according to UL-94 (Underwriter's Laboratories Subject 94) and other excellent ratings in related test methods are attained.

The composition, as defined above, comprises the following components:

### Component a)

The term phosphinic acid comprises within its scope derivatives of phosphinic acid, H₂P(═O)OH, wherein one or two hydrogen atoms, which are directly attached to the phosphorus atom, have been substituted by organic substituents, such as C₁-C₈alkyl.

The term phosphinic acid also comprises within its scope the tautomeric form HP(OH)₂, wherein the hydrogen atom which is directly attached to the phosphorus atom is substituted by organic substituents, such as C₁-C₈alkyl.

The term salt of phosphinic acid comprises within its scope preferably a metal salt, for example an alkali metal or alkaline earth metal salt, e.g. the sodium, potassium, magnesium or calcium salt or the iron(II), iron(III), zinc or boron salt.

R¹ and R² defined as C₁-C₈alkyl is straight or, where possible branched C₁-C₈alkyl and is for example methyl, ethyl, n-propyl, n-butyl, sec-butyl, tert-butyl, n-hexyl, n-octyl or 2-ethylhexyl.

R³ defined as C₁-C₁₀alkylene is straight chain or, where possible branched C₁-C₁₀alkylene, e.g. methylene, ethylene, 1,2- or 1,3-propylene or 1,2-, 1,3- or 1,4-butylene.

R³ defined as C₂-C₁₀alkylene interrupted by phenylene is, for example a bivalent group of the partial formulae

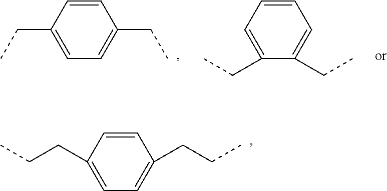

wherein the dotted lines point to the carbon atom of attachment.

R³ defined as phenylene is 1,2-, 1,3- or 1,4-phenylene.

R³ defined as (C₁-C₄alkyl)₁₋₃phenylene is, for example, 1,2-, 1,3- or 1,4-phenylene substituted by 1-3 methyl or ethyl groups.

R³ defined as phenyl-C₁-C₄alkylene is, for example, one of the above-mentioned C₁-C₈alkyl groups substituted by phenyl.

According to a preferred embodiment, the composition comprises the aluminium salt of diethylphosphinic acid.

According to an alternative embodiment, the term salt comprises non-metallic salts, e.g. the acid addition salts obtainable by reaction of phosphinic acid with ammonia, amines or amides, e.g. the (C₁-C₄alkyl)₄N⁺, (C₁-C₄alkyl)₃NH⁺, (C₂-C₄alkylOH)₄N⁺, (C₂-C₄alkylOH)₃NH⁺, (C₂-C₄alkylOH)₂N(CH₃)₂⁺, (C₂-C₄alkylOH)₂NHCH₃⁺, (C₆H₅)₄N⁺, (C₆H₅)₃NH⁺, (C₆H₅CH₃)₄N⁺, (C₆H₅CH₃)₃NH⁺, NH₄⁺, melamine or guanidine salt.

Among the acid addition salts the ammonium, (C₁-C₄alkyl)₁₋₄ammonium or (2-hydroxyethyl)₁₋₄ammonium, e.g. tetramethylammonium, tetraethylammonium, the 2-hydroxyethyl-trimethylammonium, melamine or guanidine salt are particularly preferred.

According to a particularly preferred embodiment, the salt of a phosphinic acid (I) is represented by the formula

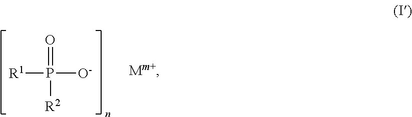

In which
one of R¹ and R² represents hydrogen or C₁-C₈alkyl; or both R¹ and R² represent C₁-C₈alkyl;
M represents (C₁-C₄alkyl)₄N, (C₁-C₄alkyl)₃NH, (C₂-C₄alkylOH)₄N, (C₂-C₄alkylOH)₃NH, (C₂-C₄alkylOH)₂N(CH₃)₂, (C₂-C₄alkylOH)₂NHCH₃, (C₆H₅)₄N, (C₆H₅)₃NH, (C₆H₅CH₃)₄N, (C₆H₅CH₃)₃NH, NH₄, melamine, guanidine, an alkali metal or earth alkali metal ion, or an aluminium, zinc, iron or boron ion;
m is a numeral from 1-3 and indicates the number of positive charges on M; and
n is a numeral from 1-3 and indicates the number of phosphinic acid anions corresponding to M^{m+}.

According to a particularly preferred embodiment, the salt of a phosphinic acid (I) of Component a) is represented by the formula

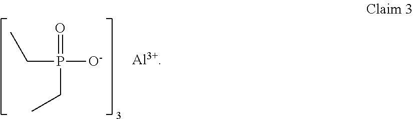

Component a) is preferably contained in the flame retardant compositions according to the invention in an amount from 0.1-45.0 wt. %, preferably 1-30.0 wt. %, based on the weight of the polymer substrate component c), and component b) is preferably contained in an amount from 0.05-5.0 wt. %, preferably 0.1-2.0 wt. %. The preferred ratio of components a):b) is in the range 50:1-1:5, preferably 20:1-1:2.

A further embodiment of the invention relates to a mixture, which comprises
a) A salt of a phosphinic acid as represented by the structural formulae (I) or (II),
   In which
   one of R¹ and R² represents hydrogen or C₁-C₈alkyl; or both R¹ and R² represent C₁-C₈alkyl; and
   R³ represents C₁-C₁₀alkylene, C₂-C₁₀alkylene interrupted by phenylene, phenylene, (C₁-C₄alkyl)₁₋₃phenylene, or phenyl-C₁-C₄alkylene; and
b) A tetraalkylpiperidine derivative selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines and 1-acyloxy-2,2,6,6-piperidines.

The mixture is useful for imparting flame retardancy to a polymer substrate.

A further embodiment of the invention relates to a process for imparting flame retardancy to a polymer substrate, which process comprises adding to a polymer substrate of component c) the above defined mixture of components a) and b).

### Component b)

A suitable tetraalkylpiperidine or tetralkylpiperazine derivative is selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines, 1-acyloxy-2,2,6,6-piperidines, 1-hydroxy-2,2,6,6-tetraalkylpiperazines, 1-alkoxy-2,2,6,6-tetraalkylpiperazines, and 1-acyloxy-2,2,6,6-piperazines.

Such compounds can be illustrated by the partial formulae

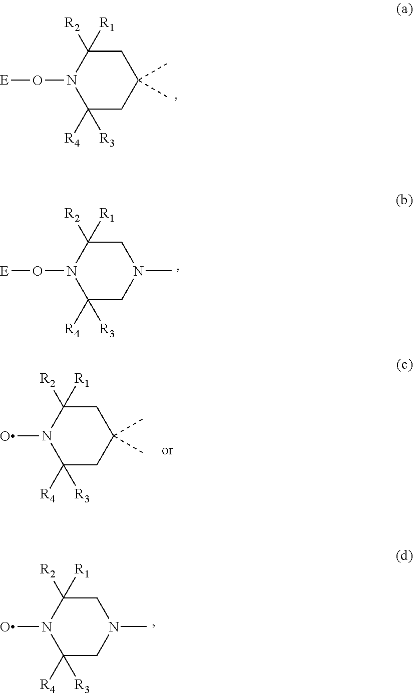

Wherein R₁-R₄ represent C₁-C₄alkyl, preferably methyl or ethyl. According to preferred embodiments, one of R₁ and R₂ and one of R₃ of R₄ represents ethyl and the other ones represent methyl or all of R₁-R₄ represent methyl; and

E represents hydrogen, C₁-C₂₀alkyl, C₅-C₆cycloalkyl or C₂-C₂₀alkyl, C₅-C₆cycloalkyl or C₂-C₂₀alkenyl with additional substituents; or represents the acyl group of a C₁-C₂₀monocarboxylic or C₂-C₂₀dicarboxylic acid.

In the compounds that correspond to the partial formula a, one of the dotted lines in 4-position of the piperidine represents a bond to hydrogen or an N-substituent and the other one represents a bond to an O-substituent or a C-substituent.

In the alternative, both dotted lines in 4-position of the piperidine represent bonds to hydrogen, O-substituents or C-substituents or represent a double bond to oxygen.

In the compounds that correspond to the partial formula b, the nitrogen in 4-position of the piperazine is bonded to hydrogen or carbon-substituents.

Representative structural formulae are given below:

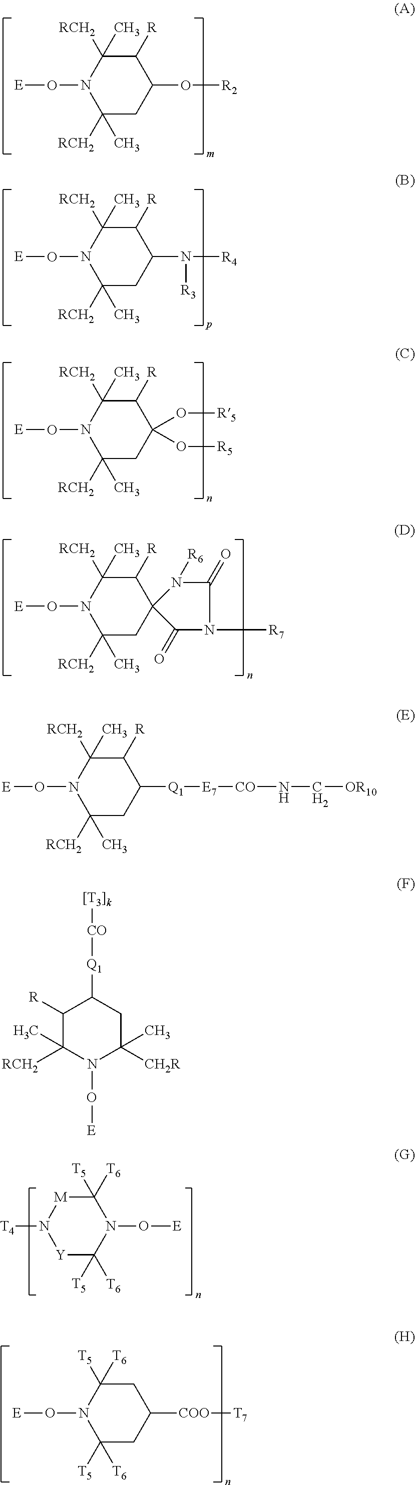

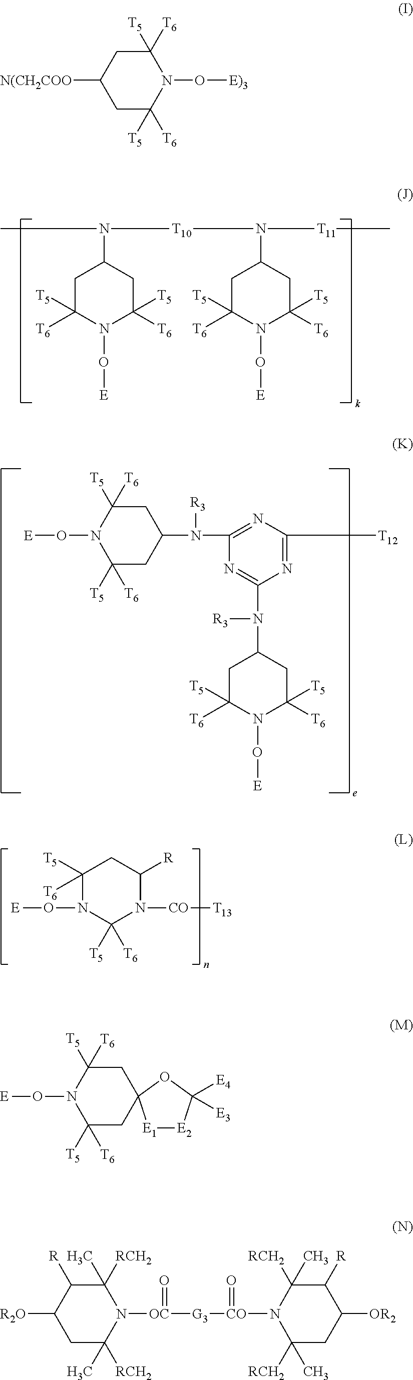

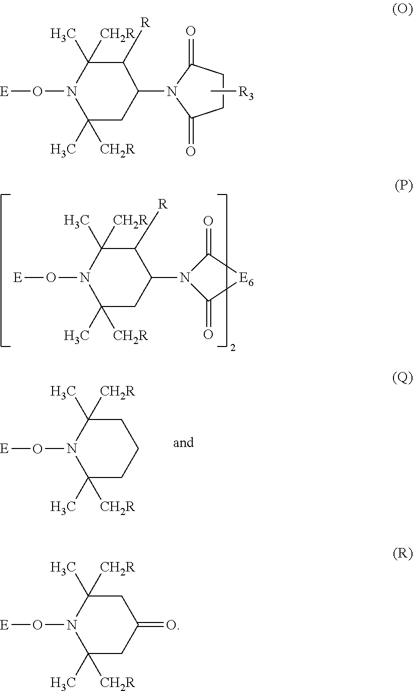

In these compounds (A)-(R)

E represents hydrogen, C₁-C₂₀alkyl, C₅-C₆cycloalkyl or C₂-C₂₀alkyl, C₅-C₆cycloalkyl or C₂-C₂₀alkenyl with additional substituents; or represents the acyl group of a C₁-C₂₀monocarboxylic or C₂-C₂₀dicarboxylic acid; or, in the alternative, the group >N—O-E is replaced with the group >N—O.

Alkyl is straight or branched and is for example methyl, ethyl, n-propyl, n-butyl, sec-butyl, tert-butyl, n-hexyl, n-octyl, 2-ethylhexyl, n-nonyl, n-decyl, n-undecyl, n-dodecyl, n-tridecyl, n-tetradecyl, n-hexadecyl or n-octadecyl.

Cycloalkyl groups include cyclopentyl and cyclohexyl; typical cycloalkenyl groups include cyclohexenyl; while typical aralkyl groups include benzyl, alpha-methyl-benzyl, alpha,alpha-dimethylbenzyl or phenethyl.

E defined as the acyl group of a C₁-C₂₀monocarboxylic acid is preferably an acyl radical selected from the group consisting of —C(═O)—H, —C(═O)—C₁-C₁₉alkyl, —C(═O)—C₂-C₁₉alkenyl, —C(═O)—C₂-C₄alkenyl-C₆-C₁₀aryl, —C(═O)—C₆-C₁₀aryl, —C(═O)—O—C₁-C₆alkyl, —C(═O)—O—C₆-C₁₀aryl, —C(═O)—NH—C₁-C₆alkyl, —C(═O)—NH—C₆-C₁₀aryl and —C(═O)—N(C₁-C₆alkyl)₂.

E defined as the acyl group of a C₂-C₂₀dicarboxylic acid is, for example, the diacyl radical derived from a monobasic organic acid having C radicals and two acid functions, e.g. a diacyl radical derived from an aliphatic, aromatic or cycloaliphatic dicarboxylic acid.

Suitable aliphatic dicarboxylic acids have from 2 to 40 C-atoms, e.g. oxalic acid, malonic acid, dimethylmalonic acid, succinic acid, pimelic acid, adipic acid, trimethyladipic acid, sebacic acid, azelaic acid and dimeric acid (dimerization products of unsaturated aliphatic carboxylic acids such as oleic acid), alkylated malonic and succinic acids, e.g. octadecylsuccinic acid.

Suitable cycloaliphatic dicarboxylic acids are, for example, 1,3-cyclobutanedicarboxylic acid, 1,3-cyclopentanedicarboxylic acid, 1,3- and 1,4-cyclohexanedicarboxylic acid, 1,3- and 1,4-(dicarboxymethyl)cyclohexane or 4,4′-dicyclohexyldicarboxylic acid.

Preferred members of this group include the acyl radical of oxalic acid, adipic acid, succinic acid, suberic acid, sebacic acid, phthalic acid dibutylmalonic acid, dibenzylmalonic acid or butyl-(3,5-di-tert-butyl-4-hydroxybenzyl)-malonic acid, or bicycloheptenedicarboxylic acid, with succinates, sebacates, phthalates and isophthalates being specific examples.

If E is a divalent acyl radical of a dicarbamic acid, it is for example an acyl radical of hexamethylenedicarbamic acid or of 2,4-toluoylenedicarbamic acid;

T is a straight or branched chain alkylene of 1 to 18 C-atoms, cycloalkylene of 5 to 18 C-atoms, cycloalkenylene of 5 to 18 C-atoms, a straight or branched chain alkylene of 1 to 4 C-atoms substituted by phenyl or by phenyl substituted by one or two alkyl groups of 1 to 4 C-atoms;
b is 1, 2 or 3 with the proviso that b does not exceed the number of C-atoms in T, and when b is 2 or 3, each hydroxyl group is attached to a different C-atoms of T;
R is hydrogen or methyl; and
m is 1 to 4.

In the compounds mentioned above when the variable m is 1,

R₂ is hydrogen, C₁-C₁₈alkyl or said alkyl optionally interrupted by one or more oxygen atoms, C₂-C₁₂alkenyl, C₆-C₁₀aryl, C₇-C₁₈aralkyl, glycidyl, the monovalent acyl radical of an aliphatic, cycloaliphatic or aromatic carboxylic acid, or a carbamic acid, for example an acyl radical of an aliphatic carboxylic acid having 2-18 C-atoms, of a cycloaliphatic carboxylic acid having 5-12 C-atoms or of an aromatic carboxylic acid having 7-15 C-atoms, or represents groups of the partial formulae

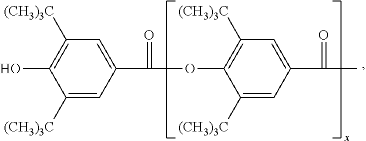

wherein x is 0 or 1,

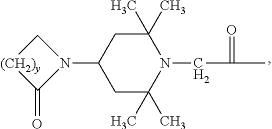

wherein y is 2-4;

### When m is 2,

R₂ is C₁-C₁₂alkylene, C₄-C₁₂alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 C-atoms, of a cycloaliphatic or aromatic dicarboxylic acid having 8-14 C-atoms, or of an aliphatic, cycloaliphatic or aromatic dicarbamic acid having 8-14 C-atoms;
Or represents groups of the partial formulae

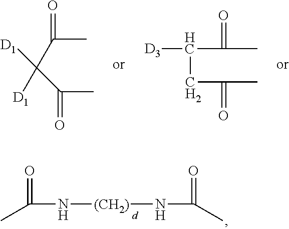

### Wherein

D₁ and D₂ are independently hydrogen, C₁-C₈ alkyl, aryl or aralkyl including the 3,5-di-t-butyl-4-hydroxybenzyl radical;
D₃ is hydrogen, C₁-C₁₈alkyl or C₁-C₂₀alkenyl; and
d is 0-20;

### When m is 3,

R₂ is a trivalent acyl radical of an aliphatic, unsaturated aliphatic, cycloaliphatic, or aromatic tricarboxylic acid;

### When m is 4,

R₂ is a tetravalent acyl radical of a saturated or unsaturated aliphatic or aromatic tetracarboxylic acid including 1,2,3,4-butanetetracarboxylic acid, 1,2,3,4-but-2-enetetracarboxylic, and 1,2,3,5- and 1,2,4,5-pentanetetracarboxylic acid;
In the compounds mentioned above when the variable p is 1, 2 or 3,
R₃ is hydrogen, C₁-C₁₂alkyl, C₅-C₇cycloalkyl, C₇-C₉aralkyl, C₂-C₁₈alkanoyl, C₃-C₅alkenoyl or benzoyl;

### When p is 1,

R₄ is hydrogen, C₁-C₁₈alkyl, C₅-C₇cycloalkyl, C₂-C₈alkenyl, unsubstituted or substituted by cyano, carbonyl or carbamide, or is aryl, aralkyl, or glycidyl, a group of the partial formula —CH₂—CH(OH)—Z or of the partial formulae —CO—Z or —CONH—Z, wherein Z is hydrogen, methyl or phenyl, or represents groups of the partial formulae

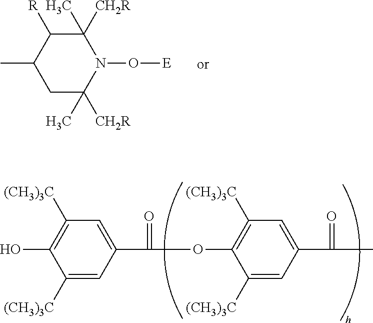

where h is 0 or 1;
R₃ and R₄ together, when p is 1, represents alkylene of 4 to 6 C-atoms, or 2-oxo-polyalkylene, or the cyclic acyl radical of an aliphatic or aromatic 1,2- or 1,3-dicarboxylic acid;

### When p is 2,

R₄ is a direct bond or is C₁-C₁₂alkylene, C₈-C₁₂arylene, xylylene, a —CH₂CH(OH)—CH₂ group or a group of the partial formula —CH₂—CH(OH)—CH₂—O—X—O—CH₂—CH(OH)—CH₂—, wherein X is C₂-C₁₀alkylene, C₆-C₁₅arylene or C₆-C₁₂cycloalkylene; or, provided that R₃ is other than alkanoyl, alkenoyl or benzoyl, R₄ additionally represents the divalent acyl radical of an aliphatic, cycloaliphatic or aromatic dicarboxylic acid or dicarbamic acid, or represents the group —CO—; or
R₄ represents a group of the partial formula

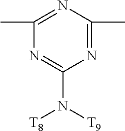

where T₈ and T₉ are independently hydrogen, C₁-C₁₈alkyl, or T₈ and T₉ together represent C₄-C₈alkylene or 3-oxapentamethylene, for instance T₈ and T₉ together are 3-oxapentamethylene;

### When p is 3,

R₄ is 2,4,6-triazinyl;
n is 1 or 2;

### When n is 1,

R₅ and R′₅ are independently C₁-C₁₂alkyl, C₂-C₁₂alkenyl, C₇-C₁₂aralkyl, or R₅ additionally represents hydrogen, or R₅ and R′₅ together are C₂-C₈alkylene or hydroxyalkylene or C₄-C₂₄acyloxyalkylene;

### When n is 2,

R₅ and R′₅ together are a group of the partial formula (—CH₂)₂C(CH₂—)₂;
R₆ is hydrogen, C₁-C₁₂alkyl, allyl, benzyl, glycidyl or C₂-C₆alkoxyalkyl; or

### When n is 1,

R₇ is hydrogen, C₁-C₁₂alkyl, C₃-C₅alkenyl, C₇-C₉aralkyl, C₅-C₇cycloalkyl, C₂-C₄hydroxyalkyl, C₂-C₆alkoxyalkyl, C₆-C₁₀ aryl, glycidyl, a group of the partial formula —(CH₂)ₜ—COO-Q or of the partial formula —(CH₂)ₜ—O—CO-Q wherein t is 1 or 2, and Q is C₁-C₄alkyl or phenyl; or
when n is 2,
R₇ is C₂-C₁₂alkylene, C₆-C₁₂arylene, a group of the partial formula

—CH₂CH(OH)—CH₂—O—X—O—CH₂—CH(OH)—CH₂—,

Wherein X is C₂-C₁₀alkylene, C₆-C₁₅arylene or C₆-C₁₂cycloalkylene, or a group of the partial formula

—CH₂CH(OZ′)CH₂—(OCH₂—CH(OZ′)CH₂)₂—,

Wherein Z′ is hydrogen, C₁-C₁₈alkyl, allyl, benzyl, C₂-C₁₂alkanoyl or benzoyl;
Q₁ is —N(R₈)— or —O—; E₇ is C₁-C₃ alkylene, the group —CH₂—CH(R₉)—O— wherein R₉ is hydrogen, methyl or phenyl, the group —(CH₂)₃—NH— or a direct bond;
R₁₀ is hydrogen or C₁-C₁₈ alkyl, R₈ is hydrogen, C₁-C₁₈alkyl, C₅-C₇cycloalkyl, C₇-C₁₂aralkyl, cyanoethyl, C₆-C₁₀aryl, the group —CH₂—CH(R₉)—OH wherein R₉ has the meaning defined above; or represents groups of the partial formulae

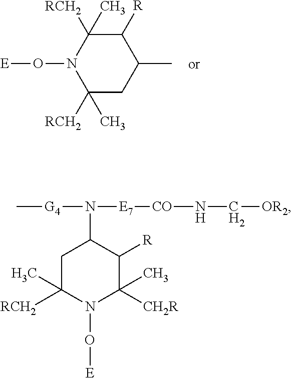

Wherein G₄ is C₂-C₁₂alkylene or C₆-C₁₂arylene; or R₈ is a group of the partial formula -E₇-CO—NH—CH₂—OR₁₀;
Formula F denotes a recurring structural unit of a polymer where T₃ is ethylene or 1,2-propylene, is the repeating structural unit derived from an alpha-olefin copolymer with an alkyl acrylate or methacrylate; for example a copolymer of ethylene and ethyl acrylate, and where k is 2 to 100;
T₄ has the same meaning as R₄ when p is 1 or 2;
T₅ is methyl;
T₆ is methyl or ethyl, or T₅ and T₆ together are tetramethylene or pentamethylene, for instance T₅ and T₆ are each methyl;
M and Y are independently methylene or carbonyl, and T₄ is ethylene where n is 2;
T₇ is as defined as R₇, and T₇ is for example octamethylene where n is 2;
T₁₀ and T₁₁ are independently alkylene of 2 to 12 C-atoms; or T₁₁ represents a group of the partial formula

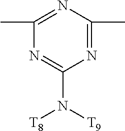

T₁₂ is piperazinyl, or represents groups of the partial formulae

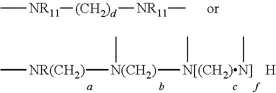

where R₁₁ is as defined as R₃ or additionally represents a group of the partial formula

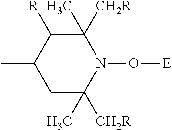

a, b and c are independently 2 or 3, and f is 0 or 1, for instance a and c are each 3, b is 2 and f is 1; and
e is 2, 3 or 4, for example 4;
T₁₃ is the same as R₂ with the proviso that T₁₃ is other than hydrogen when n is 1;
E₁ and E₂, being different, each are —CO— or —N(E₅)— where E₅ is hydrogen, C₁-C₁₂alkyl or C₄-C₂₄alkoxycarbonylalkyl, for instance E₁ is —CO— and E₂ is —N(E₅)-;
E₃ is hydrogen, C₁-C₃₀alkyl, phenyl, naphthyl, said phenyl or said naphthyl substituted by chlorine or by C₁-C₄alkyl, or C₇-C₁₂phenylalkyl, or said phenylalkyl substituted by C₁-C₄alkyl of 1 to 4 C-atoms;
E₄ is hydrogen, alkyl of 1 to 30 C-atoms, phenyl, naphthyl or phenylalkyl of 7 to 12 C-atoms, or
E₃ and E₄ together are polymethylene of 4 to 17 C-atoms, or said polymethylene substituted by up to four C₁-C₄alkyl groups, for example methyl;
E₆ is an aliphatic or aromatic tetravalent radical;
R₂ of formula (N) is a previously defined when m is 1;
G₁ a direct bond, C₁-C₁₂ alkylene, phenylene or —NH-G′-NH wherein G′ is C₁-C₁₂ alkylene.

Suitable tetraalkylpiperidine or tetralkylpiperazine derivatives are, for example, compounds of the formulae 1-12:

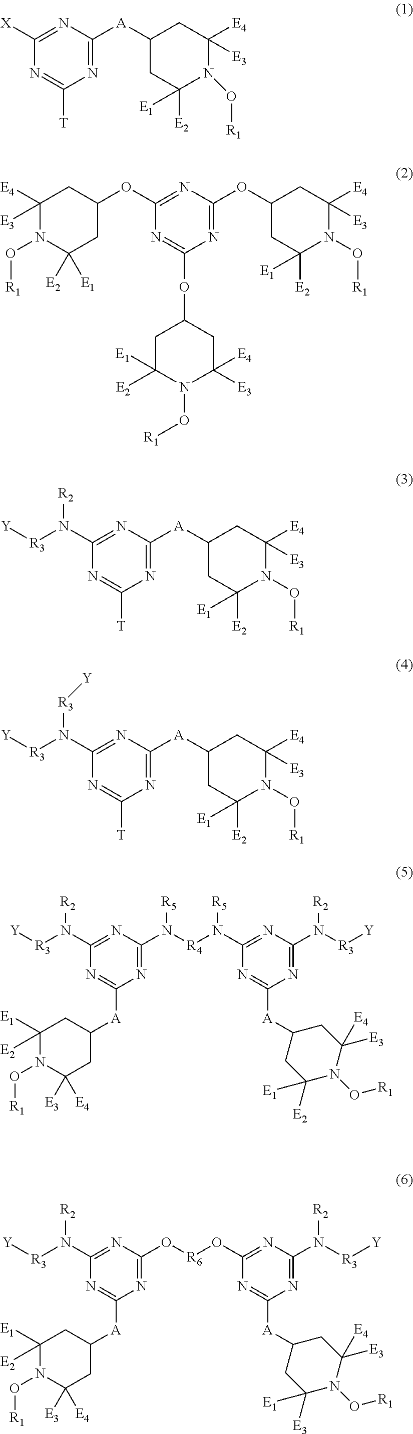

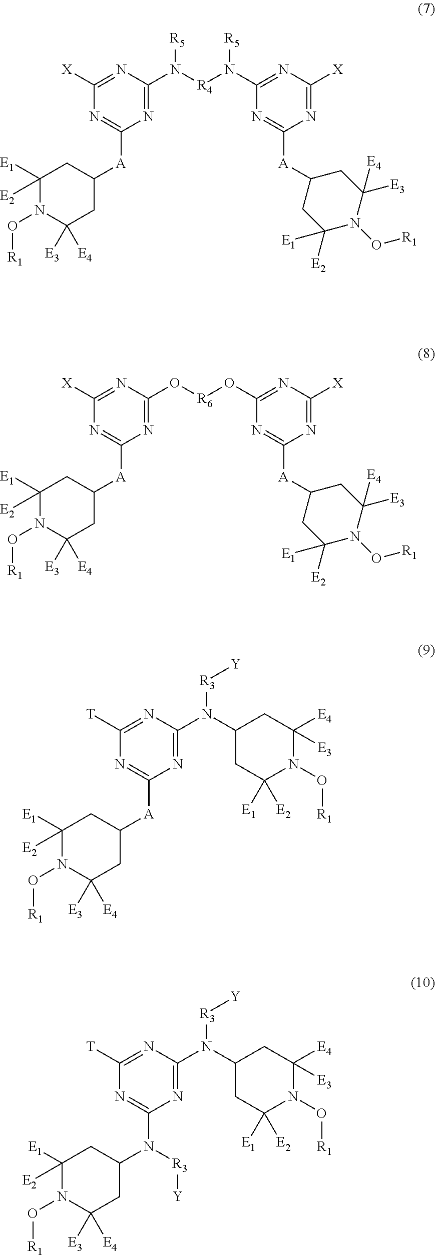

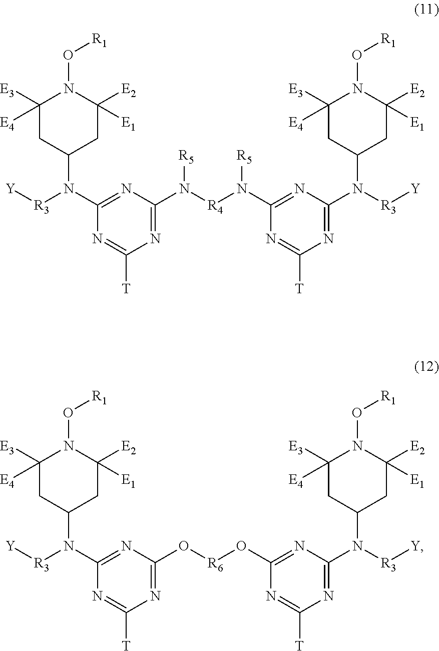

wherein
E₁, E₂, E₃ and E₄ are independently C₁-C₄alkyl, or E₁ and E₂ are independently C₁-C₄alkyl and E₃ and E₄ taken together are pentamethylene, or E₁ and E₂; and E₃ and E₄ each taken together are pentamethylene;
R₁ is C₁-C₁₈alkyl, C₅-C₁₂cycloalkyl, a bicyclic or tricyclic hydrocarbon radical of 7 to 12 carbon atoms, C₇-C₁₅-phenylalkyl, C₆-C₁₀aryl or said aryl substituted by one to three C₁-C₈alkyl;
R₂ is hydrogen or a linear or branched chain C₁-C₁₂ alkyl;
R₃ is alkylene of 1 to 8 carbon atoms, or R₃ is —CO—, —CO—R₄—, —CONR₂—, or —CO—NR₂—R₄;
R₄ is C₁-C₈ alkylene;
R₅ is hydrogen, linear or branched chain C₁-C₁₂alkyl, or represents a group of the partial formula

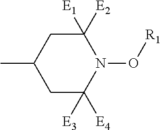

Or, when R₄ is ethylene, two R₅ methyl substituents can be linked by a direct bond with the triazine bridging group —N(R₅)—R₄—N(R₅)— forming a piperazin-1,4-diyl group;
R₆ is C₂-C₈alkylene or represents a group of the partial formula

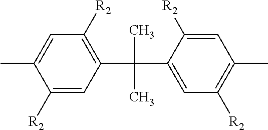

with the proviso that Y is other than —OH when R₆ is the structure depicted above;
A is —O— or —NR₇— where R₇ is hydrogen, straight or branched chain C₁-C₁₂alkyl; or R₇ is a group of the partial formula

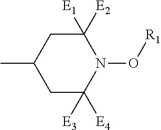

T is phenoxy, phenoxy substituted by one or two C₁-C₈alkyl or C₁-C₈alkoxy or —N(R₂)₂ with the stipulation that R₂ is other than hydrogen; or T is a group of the partial formula

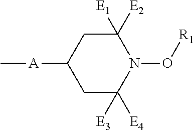

### X is —NH₂, —NCO, —OH, —O-glycidyl, or —NHNH₂, and

Y is —OH, —NH₂, —NHR₂ where R₂ is other than hydrogen; or Y is —NCO, —COOH, oxiranyl, —O-glycidyl, or —Si(OR₂)₃;
Or the combination R₃—Y— is —CH₂CH(OH)R₂ where R₂ is alkyl or said alkyl interrupted by one to four oxygen atoms, or R₃—Y— is —CH₂OR₂; or
Wherein the hindered amine compound is a mixture of N,N′,N′″-tris{2,4-bis[(1-hydrocarbyloxy-2,2,6,6-tetramethylpiperidin-4-yl)alkylamino]-s-triazin-6-yl}-3,3′-ethylenediiminodipropylamine; N,N′,N″-tris{2,4-bis[(1-hydrocarbyloxy-2,2,6,6-tetramethylpiperidin-4-yl)alkylamino]-s-triazin-6-yl}-3,3′-ethylenediiminodipropylamine, and bridged derivatives as described by formulae

R₁NH—CH₂CH₂CH₂NR₂CH₂CH₂NR₃CH₂CH₂CH₂NHR₄ (13)

T-E₁-T₁ (14)

T-E₁ (15)

G-E₁-G₁-E₁-G₂ (16)

Where in the tetraamine (13)
R₁ and R₂ are the s-triazine moiety E; and one of R₃ and R₄ is the s-triazine moiety E with the other ones of R₃ or R₄ being hydrogen;

### E is

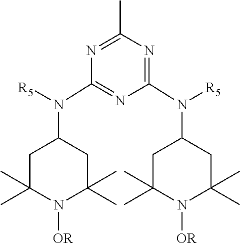

R is methyl, propyl, cyclohexyl or octyl, for instance cyclohexyl;
R₅ is C₁-C₁₂alkyl, for example n-butyl;
where in the compound of formula (14) and (15), when R is propyl, cyclohexyl or octyl,
T and T₁ are each a tetraamine substituted by R₁-R₄ as is defined for formula 13, where
(1) One of the s-triazine moieties E in each tetraamine is replaced by the group E₁ which forms a bridge between two tetraamines T and T₁;
   E₁ is a group of the partial formula

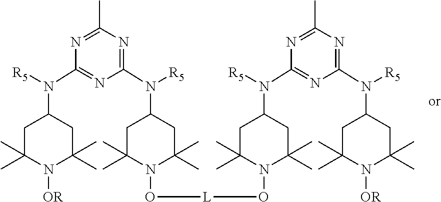

(2) The group E₁ can have both termini in the same tetraamine T as in formula 15, where two of the E moieties of the tetraamine are replaced by one E₁ group; or
(3) All three s-triazine substituents of tetraamine T can be E₁ such that one E₁ links T and T₁ and a second E₁ has both termini in tetraamine T;
   L is propanediyl, cyclohexanediyl or octanediyl;
   Where in the compound (16)
   G, G₁ and G₂ are each tetraamines substituted by R₁-R₄ as defined for formula I, except that G and G₂ each have one of the s-triazine moieties E replaced by E₁, and G₁ has two of the triazine moieties E replaced by E₁, so that there is a bridge between G and G₁ and a second bridge between G₁ and G₂;
   which mixture is prepared by reacting two to four equivalents of 2,4-bis[(1-hydrocarbyloxy-2,2,6,6-tetramethylpiperidin-4-yl)butylamino]-6-chloro-s-triazine with one equivalent of N,N′-bis(3-aminopropyl)ethylenediamine;
   Or the hindered amine is a compound of the formula (17)

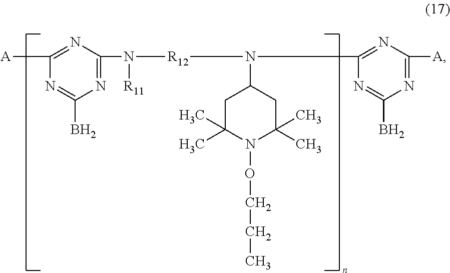

In which the index n ranges from 1 to 15;
R₁₂ is C₂-C₁₂alkylene, C₄-C₁₂alkenylene, C₅-C₇cycloalkylene, C₅-C₇cycloalkylene-di(C₁-C₄alkylene), C₁-C₄alkylene-di(C₅-C₇cycloalkylene), phenylene-di(C₁-C₄alkylene) or
C₄-C₁₂alkylene interrupted by 1,4-piperazinediyl, —O— or >N—X₁ with X₁ being C₁-C₁₂acyl or
(C₁-C₁₂alkoxy)carbonyl or having one of the definitions of R₁₄ given below other than hydrogen; or R₁₂ is a group of the partial formulae:

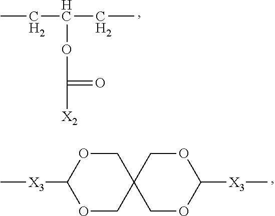

With X₂ being C₁-C₁₈alkyl, C₅-C₁₂cycloalkyl which is unsubstituted or substituted by 1, 2 or 3 C₁-C₄alkyl; phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; and
The radicals X₃ being independently of one another C₂-C₁₂alkylene;
R₁₃, R₁₄ and R₁₅, which are identical or different, are hydrogen, C₁-C₁₈alkyl, C₅-C₁₂cycloalkyl which is unsubstituted or substituted by 1, 2 or 3 C₁-C₄alkyl; C₃-C₁₈alkenyl, phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; tetrahydrofurfuryl or
C₂-C₄alkyl which is substituted in the 2, 3 or 4 position by —OH, C₁-C₈alkoxy, di(C₁-C₄alkyl)amino or a group of the partial formula:

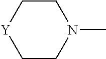

with Y being —O—, —CH₂—, —CH₂CH₂— or >N—CH₃, or —N(R₁₄)(R₁₅) is additionally the group

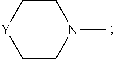

The radicals A are independently of one another —OR₁₃, —N(R₁₄)(R₁₅) or a group of the partial formula:

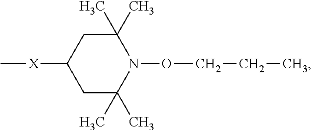

### Wherein

### X is —O— or >N—R₁₆;

R₁₆ is hydrogen, C₁-C₁₈alkyl, C₃-C₁₈alkenyl, C₅-C₁₂cycloalkyl which is unsubstituted or substituted by 1, 2 or 3 C₁-C₄alkyl; C₇-C₉phenylalkyl which is unsubstituted or substituted on the phenyl by 1, 2 or 3 C₁-C₄alkyl; tetrahydrofurfuryl, a group of the partial formula:

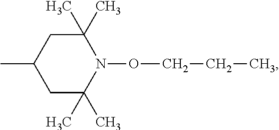

or C₂-C₄alkyl which is substituted in the 2, 3 or 4 position by —OH, C₁-C₈alkoxy, di(C₁-C₄alkyl)amino or the group of the partial formula

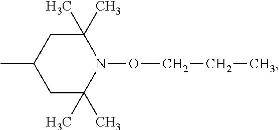

R₁₁ has one of the definitions given for R₁₆; and
the radicals B have independently of one another one of the definitions given for A.

The tetraalkylpiperidine and tetraalkylpiperazine compounds are known in the art, also known as N-alkoxy hindered amines and NOR-hindered amines or NOR-hindered amine light stabilizers or NOR-HALS, such as the ones disclosed in U.S. Pat. Nos. 5,004,770, 5,204,473, 5,096,950, 5,300,544, 5,112,890, 5,124,378, 5,145,893, 5,216,156, 5,844,026, 6,117,995 or 6,271,377.

U.S. Pat. No. 6,271,377, and Published U.S. application Ser. No. 09/505,529, filed Feb. 17, 2000, and 09/794,710, filed Feb. 27, 2001 disclose hindered hydroxyalkoxyamine stabilizers. Hindered hydroxyalkoxyamine stabilizers are also known as N-hydroxyalkoxy hindered amines, or NORol-HALS.

Representative structures are the following:

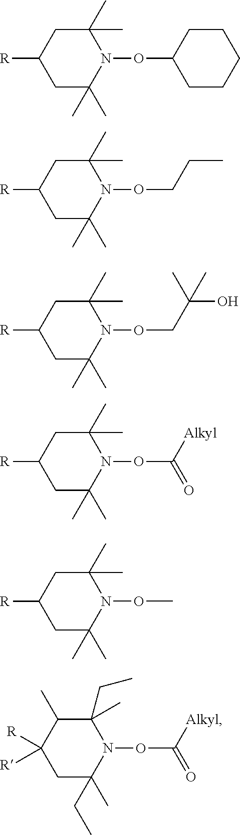

Wherein the definitions of R and R′ include N-, O- or C-substituents.

When the group E is —O—C(O)—C₁-C₁₈alkyl, the compounds are hydroxylamine esters.

The hydroxylamines are reacted with an acid derivative to form the final hydroxylamine ester. Such esterification processes are known and described in the literature.

The preparation of particularly suitable compounds is described in the International Patent Application WO 01/90113.

According to a preferred embodiment, the tetraalkylpiperidine derivative is selected from the group of 2,2,6,6-tetraalkylpiperidine-1-oxides of the formula

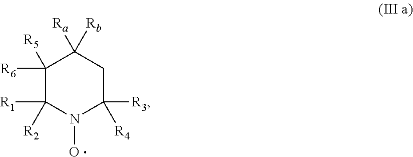

1-hydroxy-2,2,6,6-tetraalkylpiperidines of the formula

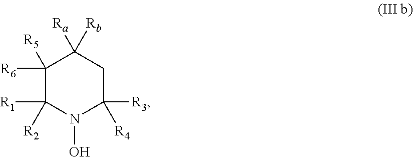

1-alkoxy-2,2,6,6-tetraalkylpiperidines of the formula

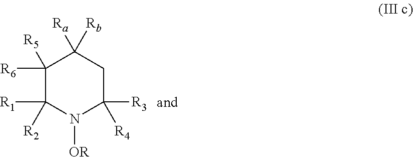

1-acyloxy-2,2,6,6-piperidines of the formula

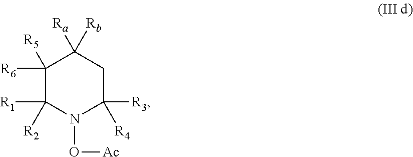

Wherein
One of Rₐ and R_{b} represents
Hydrogen or an N-substituent and the other one represents an O-substituent or a C-substituent; or
Both Rₐ and R_{b} represent hydrogen, O-substituents or C-substituents;
R represents C₁-C₂₀alkyl, C₅-C₆cycloalkyl or C₂-C₂₀alkyl, C₅-C₆cycloalkyl or C₂-C₂₀alkenyl with additional substituents;
Ac represents the acyl group of a C₁-C₂₀monocarboxylic or C₁-C₂₀dicarboxylic acid; and
R₁-R₄ each represent C₁-C₄alkyl; and
R₅ and R₆, independently of one another, represent hydrogen or a substituent selected from the group consisting of C₁-C₄-alkyl, C₁-C₃alkylphenyl and phenyl; and
R₅ and R₆ together represent oxo.

According to a preferred embodiment, the composition comprises as Component b) at least one tetraalkylpiperidine derivative III a, III b, III c or III d,
Wherein
One of Rₐ and R_{b} represents
Hydrogen or an N-substituent and the other one represents an O-substituent or a C-substituent; or
Both Rₐ and R_{b} represent hydrogen, O-substituents or C-substituents;
R represents C₁-C₈alkyl, C₅-C₆cycloalkyl or C₂-C₈alkyl, C₅-C₆cycloalkyl or C₂-C₈alkenyl with additional substituents;
Ac represents the acyl group of a C₁-C₈carboxylic acid; and
R₁-R₄ are each methyl; and
R₅ and R₆ each represent hydrogen.

According to a particularly preferred embodiment, the composition comprises as Component b) at least one tetraalkylpiperidine derivative III a, III b, III c or III d,
Wherein
One of Rₐ and R_{b} represents
Hydrogen or an N-substituent and the other one represents an O-substituent or a C-substituent; or
Both Rₐ and R_{b} represent O-substituents or C-substituents;
R represents C₁-C₈alkyl, C₅-C₆cycloalkyl or C₂-C₈alkyl, C₅-C₆cycloalkyl or C₂-C₈alkenyl substituted by hydroxy;
Ac represents the acyl group of a C₁-C₈carboxylic acid; and
R₁-R₄ are each methyl; and
R₅ and R₆ each represent hydrogen.

According to a preferred embodiment, Component b) consists of at least one tetraalkylpiperidine derivative III c or III d selected from the group consisting of
1-Cyclohexyloxy-2,2,6,6-tetramethyl-4-octadecylaminopiperidine, bis(1-Octyloxy-2,2,6,6-tetramethylpiperidin-4-yl)sebacate (Tinuvin NOR 371®),
2,4-bis[(1-Cyclohexyloxy-2,2,6,6-tetramethylpiperidin-4-yl)butylamino]-6-(2-hydroxyethylamino-s-triazine,
bis(1-Cyclohexyloxy-2,2,6,6-tetramethylpiperidin-4-yl)adipate,
2,4-bis[(1-cyclohexyloxy-2,2,6,6-tetramethylpiperidin-4-yl)butylamino]-6-chloro-s-triazine,
1-(2-Hydroxy-2-methylpropoxy)-4-hydroxy-2,2,6,6-tetramethylpiperidine,
1-(2-Hydroxy-2-methylpropoxy)-4-oxo-2,2,6,6-tetramethylpiperidine,
1-(2-Hydroxy-2-methylpropoxy)-4-octadecanoyloxy-2,2,6,6-tetramethylpiperidine,
bis(1-(2-Hydroxy-2-methylpropoxy)-2,2,6,6-tetramethylpiperidin-4-yl)sebacate,
bis(1-(2-Hydroxy-2-methylpropoxy)-2,2,6,6-tetramethylpiperidin-4-yl)adipate,
2,4-bis{N-[1-(2-Hydroxy-2-methylpropoxy)-2,2,6,6-tetramethylpiperidin-4-yl]-N-butylamino}-6-(2-hydroxyethylamino)-s-triazine,
The reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine),
2,4-bis[(1-Cyclohexyloxy-2,2,6,6-tetramethylpiperidin-4-yl)butylamino]-6-(2-hydroxyethylamino-s-triazine,
The oligomeric compound which is the condensation product of 4,4′-hexamethylenebis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine,
The compound of the formula

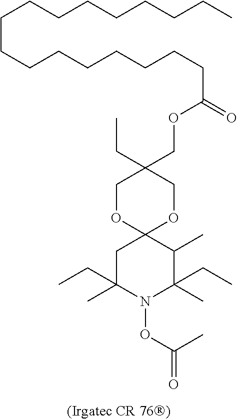

And the compound of the formula

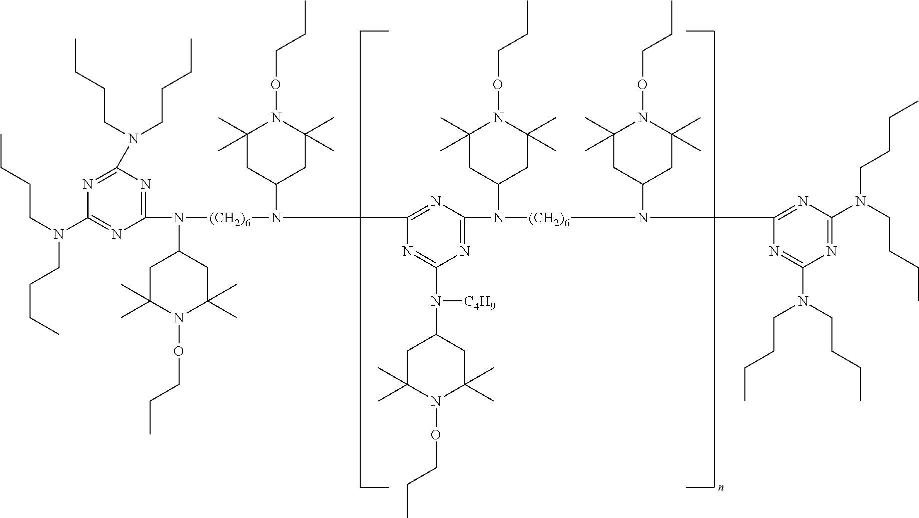

in which n is from 1 to 15 (Flamestab NOR116®).

The above mentioned compounds are partly items of commerce. Representative compounds are marketed by Ciba under the following trade names Flamestab NOR116®, Tinuvin NOR371® or Irgatec CR 76®.

### Component c)

The term polymer substrate comprises within its scope thermoplastic polymers or thermosets.

A list of suitable thermoplastic polymers is given below:
1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be cross linked), for example high density polymethylene (HDPE), high density and high molecular weight polyethylene (HDPEHMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).
   Polyolefins, i.e. the polymers of monoolefins exemplified in the preceding paragraph, preferably polyethylene and polypropylene, can be prepared by different and especially by the following methods:
   a) Radical polymerisation (normally under high pressure and at elevated temperature).
   b) Catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either α- or σ-bond coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, and amine or silyl ether groups. These catalyst systems are usually termed Phillips, Standard Oil Indiana, Ziegler-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch;
   The homopolymers and copolymers mentioned above may have a stereo structure including syndiotactic, isotactic, hemi-isotactic or atactic; where atactic polymers are preferred. Stereo block polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic; where atactic polymers are preferred. Stereo block polymers are also included;
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   b) Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
   c) Hydrogenated aromatic polymers derived from hydrogenation of polymers mentioned under 6a). Homopolymers and copolymers may have a stereo structure including syndiotactic, isotactic, hemi-isotactic or atactic; where atactic polymers are preferred. Stereo block polymers are also included.
7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulphochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes, which contain ethylene oxide as a co-monomer; polyacetals modified with thermoplastic polyurethanes, acrylates or MBS.
14. Polyphenylene oxides and sulphides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and co-polyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or co-polyamides modified with EPDM or ABS; and polyamides condensed during processing (RIM polyamide systems).
17. Polyureas, polyimides, polyamide imides, polyether imides, polyester imides, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block co-polyether esters derived from hydroxyl-terminated polyethers; and also polyesters modified with polycarbonates or MBS.
19. Polyketones.
20. Polysulphones, polyether sulphones and polyether ketones.
21. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
22. Polycarbonates that correspond to the general formula:

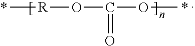

Such Polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Pat. Nos. 3,030,331; 3,169,121; 4,130,458; 4,263,201; 4,286,083; 4,552,704; 5,210,268; and 5,606,007. A combination of two or more polycarbonates of different molecular weights may be used.
Preferred are polycarbonates obtainable by reaction of a diphenol, such as bisphenol A, with a carbonate source. Examples of suitable diphenols are:

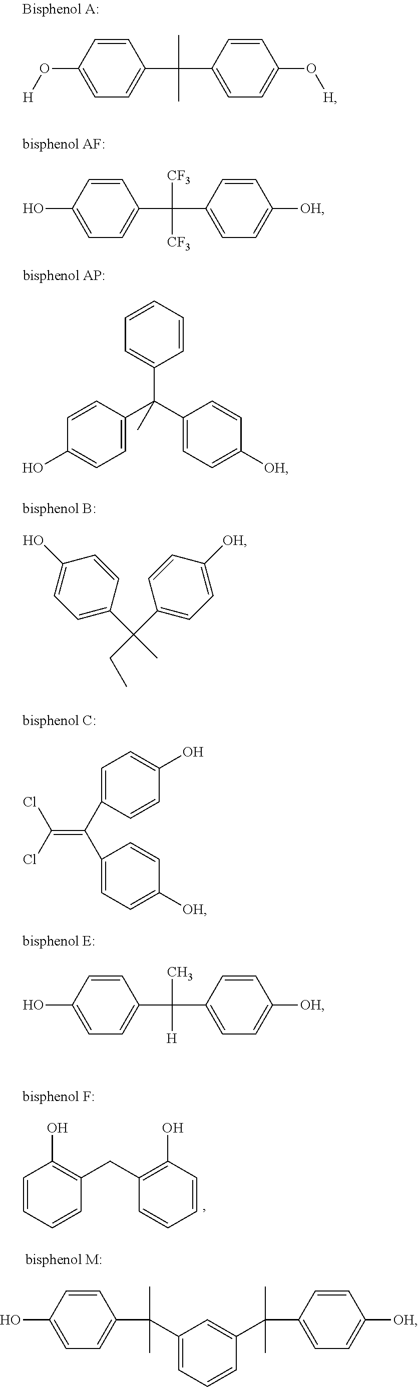

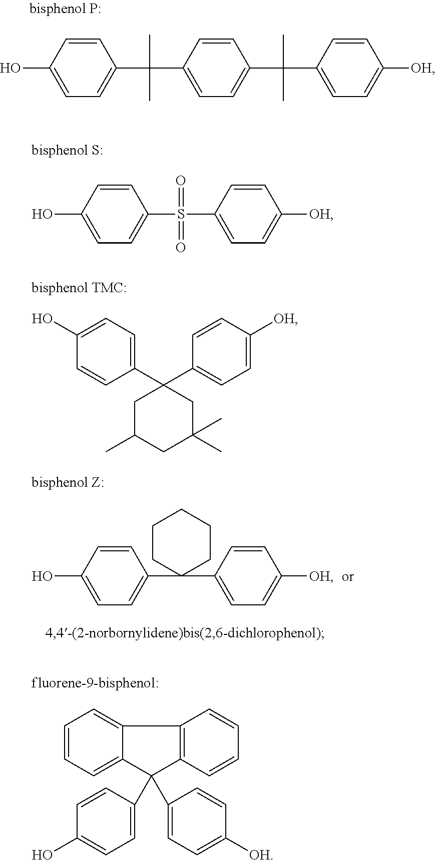

The carbonate source may be a carbonyl halide, a carbonate ester or a haloformate. Suitable carbonate halides are phosgene or carbonylbromide. Suitable carbonate esters are dialkylcarbonates, such as dimethyl- or diethylcarbonate, diphenyl carbonate, phenyl-alkylphenylcarbonate, such as phenyl-tolylcarbonate, dialkylcarbonates, such as dimethyl- or diethylcarbonate, di-(halophenyl)carbonates, such as di-(chlorophenyl)carbonate, di-(bromophenyl)carbonate, di-(trichlorophenyl)carbonate or di(trichlorophenyl)carbonate, di-(alkylphenyl)carbonates, such as di-tolylcarbonate, naphthylcarbonate, dichloronaphthylcarbonate and others.

The polymer substrate mentioned above, which comprises polycarbonates or polycarbonate blends is a polycarbonate-copolymer, wherein isophthalate/terephthalate-resorcinol segments are present. Such polycarbonates are commercially available, e.g. Lexan® SLX (General Electrics Co. USA). Other polymeric substrates of component b) may additionally contain in the form as admixtures or as copolymers a wide variety of synthetic polymers including polyolefins, polystyrenes, polyesters, polyethers, polyamides, poly(meth)acrylates, thermoplastic polyurethanes, polysulphones, polyacetals and PVC, including suitable compatibilizing agents. For example, the polymer substrate may additionally contain thermoplastic polymers selected from the group of resins consisting of polyolefins, thermoplastic polyurethanes, styrene polymers and copolymers thereof. Specific embodiments include polypropylene (PP), polyethylene (PE), polyimide (PA), polybutylene terephthalate (PBT), polyethylene terephthalate (PET), glycolmodified polycyclohexylenemethylene terephthalate (PCTG), polysulphone (PSU), polymethylmethacrylate (PMMA), thermoplastic polyurethane (TPU), acrylonitrilebutadiene-styrene (ABS), acrylonitrile-styrene-acrylic ester (ASA), acrylonitrileethylene-propylene-styrene (AES), styrene-maleic anhydride (SMA) or high impact polystyrene (HIPS).
23. Epoxy resins consisting of a di- or polyfunctional epoxide compound, wherein at least two epoxy groups of the partial formula

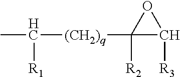

are present, which are attached directly to carbon, oxygen, nitrogen or sulphur atoms, and wherein q represents zero, R₁ and R₃ both represent hydrogen and R₂ represents hydrogen or methyl; or wherein q represents zero or 1, R₁ and R₃ together form the —CH₂—CH₂— or —CH₂—CH₂—CH₂— groups and R₂ represents hydrogen.
Suitable hardener components are, for example, amine and anhydride hardeners such as polyamines, e.g. ethylenediamine, diethylenetriamine, triethylenetriamine, hexamethylenediamine, methanediamine, N-aminoethyl piperazine, diaminodiphenylmethane [DDM], alkyl-substituted derivatives of DDM, isophoronediamine [IPD], diaminodiphenylsulphone [DDS], 4,4′-methylenedianiline [MDA], or m-phenylenediamine [MPDA]), polyamides, alkyl/alkenyl imidazoles, dicyandiamide [DICY], 1,6-hexamethylene-bis-cyanoguanidine, or acid anhydrides, e.g. dodecenylsuccinic acid anhydride, hexahydrophthalic acid anhydride, tetrahydrophthalic acid anhydride, phthalic acid anhydride, pyromellitic acid anhydride, and derivatives thereof.

A preferred embodiment of the invention relates to compositions which comprise as component c) thermoplastic polymers. Preferred thermoplastic polymers include polyolefin homo- and copolymers, copolymers of olefins vinyl monomers, styrenic homopolymers and copolymers thereof.

Advantageously, the melamine and guanidine salts (I) and (II) are ground to a fine powder with an average particle size below 100 μm prior to their application in polymer substrates as it is observed that the flame retardant properties of the inventive compositions are improved by small particle sizes.

### Additional Components

The instant invention further pertains to a composition, which comprises, in addition to the components a), b) and c), as defined above, as optional components, additional flame retardants and further additives selected from the group consisting of so-called anti-dripping agents and polymer stabilizers.

Representative phosphorus containing flame retardants are for example:

Tetraphenyl resorcinol diphosphate (Fyrolflex® RDP, Akzo Nobel), resorcinol diphosphate oligomer (RDP), triphenyl phosphate, tris(2,4-di-tert-butylphenyl)phosphate, ethylenediamine diphosphate (EDAP), ammonium polyphosphate, diethyl-N,N-bis(2-hydroxyethyl)aminomethyl phosphonate, hydroxyalkyl esters of phosphorus acids, salts of hypophosphoric acid (H₃PO₂), particularly the Ca²⁺, Zn²⁺, or Al³⁺ salts, tetrakis(hydroxymethyl)phosphonium sulphide, triphenylphosphine, derivatives of 9,10-dihydro-9-oxa-10-phosphorylphenanthrene-10-oxide (DOPO), and phosphazene flame-retardants.

Nitrogen containing flame retardants are, for example, isocyanurate flame retardants, such as polyisocyanurate, esters of isocyanuric acid or isocyanurates. Representative examples are hydroxyalkyl isocyanurates, such as tris-(2-hydroxyethyl)isocyanurate, tris(hydroxymethyl)isocyanurate, tris(3-hydroxy-n-proyl)isocyanurate or triglycidyl isocyanurate.

Nitrogen containing flame-retardants include further melamine-based flame-retardants. Representative examples are: melamine cyanurate, melamine borate, melamine phosphate, melamine pyrophosphate, melamine polyphosphate, melamine ammonium polyphosphate, melamine ammonium pyrophosphate, dimelamine phosphate and dimelamine pyrophosphate.

Further examples are: benzoguanamine, tris(hydroxyethyl)isocyanurate, allantoin, glycoluril, melamine cyanurate, melamine phosphate, dimelamine phosphate, urea cyanurate, ammonium polyphosphate, a condensation product of melamine from the series melem, melam, melon and/or a higher condensed compound or a reaction product of melamine with phosphoric acid or a mixture thereof.

Representative organohalogen flame retardants are, for example:

Polybrominated diphenyl oxide (DE-60F, Great Lakes Corp.), decabromodiphenyl oxide (DBDPO; Saytex® 102E), tris[3-bromo-2,2-bis(bromomethyl)propyl]phosphate (PB 370®, FMC Corp.), tris(2,3-dibromopropyl)phosphate, tris(2,3-dichloropropyl)phosphate, chlorendic acid, tetrachlorophthalic acid, tetrabromophthalic acid, poly-α-chloroethyl triphosphonate mixture, tetrabromobisphenol A bis(2,3-dibromopropyl ether) (PE68), brominated epoxy resin, ethylene-bis(tetrabromophthalimide) (Saytex® BT-93), bis(hexachlorocyclopentadieno)cyclooctane (Declorane Plus®), chlorinated paraffins, octabromodiphenyl ether, hexachlorocyclopentadiene derivatives, 1,2-bis(tribromophenoxy)ethane (FF680), tetrabromo-bisphenol A (Saytex® RB100), ethylene bis-(dibromo-norbornanedicarboximide) (Saytex® BN-451), bis-(hexachlorocycloentadeno) cyclooctane, PTFE, tris-(2,3-dibromopropyl)-isocyanurate, and ethylene-bis-tetrabromophthalimide.

The organohalogen flame retardants mentioned above are routinely combined with an inorganic oxide synergist. Most common for this use are zinc or antimony oxides, e.g. Sb₂O₃ or Sb₂O₅. Boron compounds are suitable, too.

Representative inorganic flame retardants include, for example, aluminum trihydroxide (ATH), boehmite (AlOOH), magnesium dihydroxide (MDH), zinc borates, CaCO₃, (organically modified) layered silicates, (organically modified) layered double hydroxides, and mixtures thereof.

The above-mentioned additional flame retardant classes are advantageously contained in the composition of the invention in an amount from about 0.5% to about 60.0% by weight of the organic polymer substrate; for instance about 1.0% to about 40.0%; for example about 5.0% to about 35.0% by weight of the polymer or based on the total weight of the composition.

According to another embodiment, the invention relates to a composition which additionally comprises as additional component so-called anti-dripping agents.

These anti-dripping agents reduce the melt flow of the thermoplastic polymer and inhibit the formation of drops at high temperatures. Various references, such as U.S. Pat. No. 4,263,201, describe the addition of anti-dripping agents to flame retardant compositions.

Suitable additives that inhibit the formation of drops at high temperatures include glass fibers, polytetrafluoroethylene (PTFE), high temperature elastomers, carbon fibers, glass spheres and the like.

The addition of polysiloxanes of different structures has been proposed in various references; cf. U.S. Pat. Nos. 6,660,787, 6,727,302 or 6,730,720.

Stabilizers are preferably halogen-free and selected from the group consisting of nitroxyl stabilizers, nitrone stabilizers, amine oxide stabilizers, benzofuranone stabilizers, phosphite and phosphonite stabilizers, quinone methide stabilizers and monoacrylate esters of 2,2′-alkylidenebisphenol stabilizers.

As mentioned above, the composition according to the invention may additionally contain one or more conventional additives, for example selected from pigments, dyes, plasticizers, antioxidants, thixotropic agents, levelling assistants, basic co-stabilizers, metal passivators, metal oxides, organophosphorus compounds, further light stabilizers and mixtures thereof, especially pigments, phenolic antioxidants, calcium stearate, zinc stearate, UV absorbers of the 2-hydroxy-benzophenone, 2-(2′-hydroxyphenyl)benzotriazole and/or 2-(2-hydroxyphenyl)-1,3,5-triazine groups.

Preferred additional additives for the compositions as defined above are processing stabilizers, such as the above-mentioned phosphites and phenolic antioxidants, and light stabilizers, such as benzotriazoles. Preferred specific antioxidants include octadecyl 3-(3,5-di-tert-butyl-4-hydroxyphenyl)propionate (IRGANOX 1076), pentaerythritol-tetrakis[3-(3,5-di-tert-butyl-4-hydroxyphenyl)propionate] (IRGANOX 1010), tris(3,5-di-tert-butyl-4-hydroxyphenyl)isocyanurate (IRGANOX 3114), 1,3,5-trimethyl-2,4,6-tris(3,5-di-tert-butyl-4-hydroxybenzyl)benzene (IRGANOX 1330), triethyleneglycol-bis[3-(3-tert-butyl-4-hydroxy-5-methylphenyl)propionate] (IRGANOX 245), and N,N′-hexane-1,6-diyl-bis[3-(3,5-di-tert-butyl-4-hydroxyphenyl)propionamide] (IRGANOX 1098). Specific processing stabilizers include tris(2,4-di-tert-butylphenyl)phosphite (IRGAFOS 168), 3,9-bis(2,4-di-tert-butylphenoxy)-2,4,8,10-tetraoxa-3,9-diphosphaspiro[5.5]undecane (IRGAFOS 126), 2,2′,2″-nitrilo[triethyl-tris(3,3′,5,5′-tetra-tert-butyl-1,1′-biphenyl-2,2′-diyl)]phosphite (IRGAFOS 12), and tetrakis(2,4-di-tert-butylphenyl)[1,1-biphenyl]-4,4′-diylbisphosphonite (IRGAFOS P-EPQ). Specific light stabilizers include 2-(2H-benzotriazole-2-yl)-4,6-bis(1-methyl-1-phenylethyl)phenol (TINUVIN 234), 2-(5-chloro(2H)-benzotriazole-2-yl)-4-(methyl)-6-(tert-butyl)phenol (TINUVIN 326), 2-(2H-benzotriazole-2-yl)-4-(1,1,3,3-tetramethylbutyl)phenol (TINUVIN 329), 2-(2H-benzotriazole-2-yl)-4-(tert-butyl)-6-(sec-butyl)phenol (TINUVIN 350), 2,2′-methylenebis(6-(2H-benzotriazol-2-yl)-4-(1,1,3,3-tetramethylbutyl)phenol) (TINUVIN 360), and 2-(4,6-diphenyl-1,3,5-triazin-2-yl)-5-[(hexyl)oxy]-phenol (TINUVIN 1577), 2-(2′-hydroxy-5′-methylphenyl)benzotriazole (TINUVIN P), 2-hydroxy-4-(octyloxy)benzophenone (CHIMASSORB 81), 1,3-bis-[(2′-cyano-3′,3′-diphenylacryloyl)oxy]-2,2-bis-{[(2′-cyano-3′,3′-diphenylacryloyl)oxy]methyl}-propane (UVINUL 3030, BASF), ethyl-2-cyano-3,3-diphenylacrylate (UVINUL 3035, BASF), and (2-ethylhexyl)-2-cyano-3,3-diphenylacrylate (UVINUL 3039, BASF).

The additives mentioned above are preferably contained in an amount of 0.01 to 10.0%, especially 0.05 to 5.0%, relative to the weight of the polymer substrate of Component c).

The incorporation of the components defined above into the polymer component is carried out by known methods such as dry blending in the form of a powder, or wet mixing in the form of solutions, dispersions or suspensions for example in an inert solvent, water or oil. The additive components a) and b) and optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers, etc.), e.g. as a dry mixture or powder, or as a solution or dispersion or suspension or melt.

The addition of the additive components to the polymer substrate can be carried out in customary mixing machines in which the polymer is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contra-rotating and co-rotating twin-screw extruders, planetary-gear extruders, ring extruders or co-kneaders. Processing machines provided with at least one gas removal compartment can be used to which a vacuum can be applied.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components is added, these can be premixed or added individually.

The additive components a) and optional further additives can also be sprayed onto the polymer substrate b). The additive mixture dilutes other additives, for example the conventional additives indicated above, or their melts so that they can be sprayed also together with these additives onto the polymer substrate. Addition by spraying during the deactivation of the polymerisation catalysts is particularly advantageous; in this case, the steam evolved may be used for deactivation of the catalyst. In the case of spherically polymerised polyolefins it may, for example, be advantageous to apply the additives of the invention, optionally together with other additives, by spraying.

The additive components a) and b) optional further additives can also be added to the polymer in the form of a master batch (“concentrate”) which contains the components in a concentration of, for example, about 1.0% to about 40.0% and preferably 2.0% to about 20.0% by weight incorporated in a polymer. The polymer is not necessarily of identical structure than the polymer where the additives are added finally. In such operations, the polymer can be used in the form of powder, granules, solutions, and suspensions or in the form of lattices.

Incorporation can take place prior to or during the shaping operation. The materials containing the additives of the invention described herein preferably are used for the production of molded articles, for example roto-molded articles, injection molded articles, profiles and the like, and especially a fibre, spun melt non-woven, film or foam.

The components a) and b) are admixed to the polymer substrate c) in concentrations of 0.1-45.0 wt. %, preferably 0.1-30.0 wt. % for component a) and 0.05-5.0 wt. %, preferably 0.1-2.0 wt. % for component b).

The preferred ratio of components a):b) is in the range 50:1-1:5, preferably 20:1-1:2.

A particularly preferred embodiment of the invention relates to a composition, particularly a flame retardant composition, which comprises
a) A salt of a phosphinic acid as represented by the structural formulae (I) or (II), in which
   one of R¹ and R² represents hydrogen or C₁-C₈alkyl; or both R¹ and R² represent C₁-C₈alkyl; and
   R³ represents C₁-C₁₀alkylene, C₂-C₁₀alkylene interrupted by phenylene, phenylene, (C₁-C₄alkyl)₁₋₃phenylene, or phenyl-C₁-C₄alkylene;
b) At least one tetraalkylpiperidine derivative III c or III d selected from the group consisting of
   1-Cyclohexyloxy-2,2,6,6-tetramethyl-4-octadecylaminopiperidine, bis(1-Octyloxy-2,2,6,6-tetramethylpiperidin-4-yl)sebacate,
   2,4-bis[(1-Cyclohexyloxy-2,2,6,6-tetramethylpiperidin-4-yl)butylamino]-6-(2-hydroxyethylamino-s-triazine,
   bis(1-Cyclohexyloxy-2,2,6,6-tetramethylpiperidin-4-yl)adipate,
   2,4-bis[(1-cyclohexyloxy-2,2,6,6-tetramethylpiperidin-4-yl)butylamino]-6-chloro-s-triazine,
   1-(2-Hydroxy-2-methylpropoxy)-4-hydroxy-2,2,6,6-tetramethylpiperidine,
   1-(2-Hydroxy-2-methylpropoxy)-4-oxo-2,2,6,6-tetramethylpiperidine,
   1-(2-Hydroxy-2-methylpropoxy)-4-octadecanoyloxy-2,2,6,6-tetramethylpiperidine,
   bis(1-(2-Hydroxy-2-methylpropoxy)-2,2,6,6-tetramethylpiperidin-4-yl)sebacate,
   bis(1-(2-Hydroxy-2-methylpropoxy)-2,2,6,6-tetramethylpiperidin-4-yl)adipate,
   2,4-bis{N-[1-(2-Hydroxy-2-methylpropoxy)-2,2,6,6-tetramethylpiperidin-4-yl]-N-butylamino}-6-(2-hydroxyethylamino)-s-triazine,
   The reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine),
   2,4-bis[(1-Cyclohexyloxy-2,2,6,6-tetramethylpiperidin-4-yl)butylamino]-6-(2-hydroxyethylamino-s-triazine,
   The oligomeric compound which is the condensation product of 4,4′-hexamethylene-bis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine,
   The compound of the formula

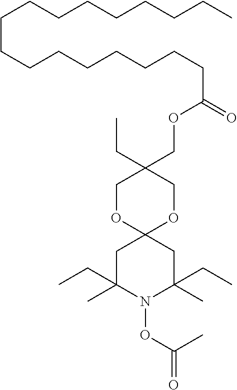

And the compound of the formula

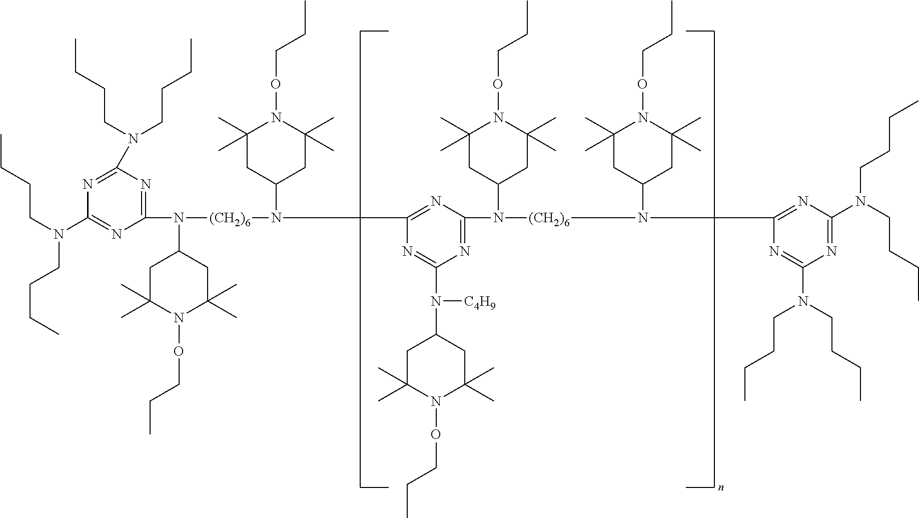

in which n is from 1 to 15; and
c) A thermoplastic polymer selected from the group consisting of polyolefin homopolymers and copolymers of olefins with each other or with vinyl monomers.

The following examples illustrate the invention, but are not to be construed to limit the scope thereof.

### EXAMPLES

### Components and Reagents Used

Moplen® HF500 N: Commercial grade polypropylene (Basell, Germany);

Tinuvin® NOR371 (NOR1): Commercial product (Ciba Inc., Switzerland);

Flamestab® NOR116 (NOR2): Commercial product (Ciba Inc., Switzerland);

Exolit OP® 1240: Diethylphosphinic acid aluminium salt (Clariant, Switzerland).

### Test Methods to Assess Flame Retardancy

UL 94 test for “Flammability of Plastic Materials for Parts in Devices and Appliances”, 5^{th} edition, Oct. 29, 1996. Ratings according to the UL 94 V test are compiled in the following table (time periods are indicated for one specimen):

| | After flame | | |
|---|---|---|---|
| Rating | time [sec] | Burning drips | Burn to clamp |
| V-0 | <10 | No | No |
| V-1 | <30 | No | No |
| V-2 | <30 | Yes | No |
| n.c. | <30 | | Yes |
| n.c. | >30 | | No |

n.c.: No classification

### Preparation of Polymeric Compositions/Extrusion

Referential Compositions according to Referential Examples 1-4 and Inventive Compositions according to Examples 1-4: Polypropylene homopolymer (MOPLEN HF 500 N) is extruded on a co-rotating twin-screw extruder ZSK25 (Coperion Werner & Pfleiderer) at a temperature of Tₘₐₓ: 230° C., a throughput rate of 4 kg/h and a rotational speed of 100 rotations per minute (rpm). To MOPLEN HF 500 N are added a basic-level stabilization composition (0.05% Ca-stearate+0.5% IRGANOX® B225; IRGANOX® B225 is a 1:1 mixture of IRGAFOS® 168 and IRGANOX® 1010) and the additives listed in Table 1.

After cooling in a water bath, the polymer strand is granulated. UL94-V test specimen (bars 125×12.5 mm, thickness=1.6 mm) and 1.0 mm plaques according to DIN 4102-B2 are prepared by injection molding on an Arburg 370S injection molding machine at 230° C. Films according to DIN 4102-B2 are obtained by compression molding.

### Testing of Polymeric Compositions

The test samples are investigated for their flame retardant behaviour in accordance with UL94-V standards after conditioning for 48 h at 23° C. and 50% relative humidity.

Additional UL94-V tests are performed after exposure of the test specimen to deionized water at 70° C. for a period of 7 days (leaching test). Subsequently, the test bars are dried in a vacuum oven at 105° C. for 24 h. Results obtained after leaching are presented in Table 2.

TABLE 1
UL94 V (1.6 mm) test results obtained with polypropylene homopolymer
containing different flame retardant compositions

| | | | Burning | |
|---|---|---|---|---|
| | | Total | drips | UL94 |
| Example | | burning | Cotton | Rating |
| Nos. | FR Additive(s) [wt. %] | time [sec] | ignition^{a)} | (1.6 mm) |
| Referential | w/o | 223 | 5 (5) | n.c. |
| Ex. 1 | | | | |
| Ref. Ex. 2 | 0.5% NOR 1 | 278 | 5 (5) | n.c. |
| Ref. Ex. 3 | 1.0% NOR 1 | 290 | 5 (5) | n.c. |
| Ref. Ex. 4 | 6.5% EXOLIT OP | 222 | 5 (5) | n.c. |
| | 1240 | | | |
| Inventive | 6.5% EXOLIT OP | 67 | 5 (5) | V-2 |
| Ex. 1 | 1240 + 0.50% | | | |
| | NOR 1 | | | |
| Inv. Ex. 2 | 6.5% EXOLIT OP | 10 | 5 (5) | V-2 |
| | 1240 + 1.0% | | | |
| | Melamine | | | |
| | hydrobromide + | | | |
| | 0.50% NOR 1 | | | |
| Inv. Ex. 3 | 7.5% EXOLIT OP | 58 | 5 (5) | V-2 |
| | 1240 + 0.50% | | | |
| | NOR 1 | | | |
| Inv. Ex. 4 | 7.5% EXOLIT OP | 57 | 5 (5) | V-2 |
| | 1240 + 0.75% | | | |
| | NOR 2 | | | |

^{a)}Number of tests (out of five tests) in which burning drips dripping from the ignited test bar ignite cotton placed underneath the test bar according to the UL94 test norm.

It can be concluded from the results reported above that the polymer compositions according to the present invention show excellent flame retardancy with self-extinguishing properties. While none of the referential compositions comprising a single additive show significant flame retardant behaviour, the inventive combinations of a phosphinate salt and a representative sterically hindered N-alkoxyamine provide efficient flame retardancy.

TABLE 2
Properties and UL94 V (1.6 mm) results of polypropylene homopolymer
test bars containing inventive flame retardant compositions after leaching
in deionized water at 70° C. for 7 days.

| | Weight loss | Change of | | Burning | |
|---|---|---|---|---|---|
| | after | sample | Total | drips | UL94 |
| Example | leaching | thickness | burning | Cotton | Rating |
| Nos. | [%] | [mm] | time [sec] | ignitions^{a)} | (1.6 mm) |
| Inventive | 0.15 | 0.05 | 61 | 5 (5) | V-2 |
| Ex. 3 | | | | | |

^{a)}Number of tests (out of five tests) in which burning drips dripping from the ignited test bar ignite cotton placed underneath the test bar according to the UL94 test norm. It can be concluded from the results presented in Table 2 that a representative polymer composition according to the present invention is characterized by excellent leaching resistance against water. Essentially no weight loss and no change of sample thickness is observed after leaching tests. Inventive Example 3 shows that UL94 V-2 rating is retained during a leaching test.

1. A composition, which comprises
a) A salt of a phosphinic acid as represented by the structural formulae 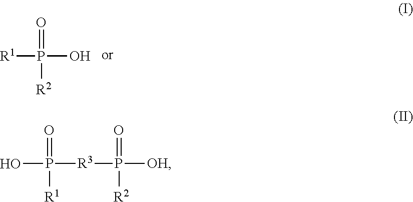
in which
one of R¹ and R² represents hydrogen or C₁-C₈alkyl; or both R¹ and R² represent C₁-C₈alkyl; and
R³ represents C₁-C₁₀alkylene, C₂-C₁₀alkylene interrupted by phenylene, phenylene, (C₁-C₄alkyl)₁₋₃-phenylene, or phenyl-C₁-C₄alkylene;
b) A tetraalkylpiperidine or tetraalkylpiperazine derivative selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines, 1-acyloxy-2,2,6,6-piperidines, 1-hydroxy-2,2,6,6-tetraalkylpiperazines, 1-alkoxy-2,2,6,6-tetraalkylpiperazines, and 1-acyloxy-2,2,6,6-piperazines; and
c) A polymer substrate.

2. A composition according to claim 1, wherein the salt of a phosphinic acid (I) of Component a) is represented by the formula 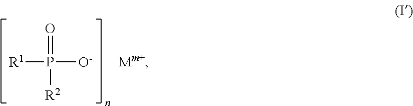
in which
one of R¹ and R² represents hydrogen or C₁-C₈alkyl; or both R¹ and R² represent C₁-C₈alkyl;
M represents (C₁-C₄alkyl)₄N, (C₁-C₄alkyl)₃NH, (C₂-C₄alkylOH)₄N, (C₂-C₄alkylOH)₃NH, (C₂-C₄alkylOH)₂N(CH₃)₂, (C₂-C₄alkylOH)₂NHCH₃, (C₆H₅)₄N, (C₆H₅)₃NH, (C₆H₅CH₃)₄N, (C₆H₅CH₃)₃NH, NH₄, melamine, guanidine, an alkali metal or earth alkali metal ion, or an aluminium, zinc, iron or boron ion;
m is a numeral from 1-3 and indicates the number of positive charges on M; and
n is a numeral from 1-3 and indicates the number of phosphinic acid anions corresponding to M^{m+}.

3. A composition according to claim 2, wherein the salt of a phosphinic acid (I) of Component a) is represented by the formula

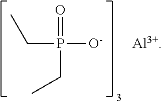

4. A composition according to claim 1, which comprises
a) The aluminium salt of a phosphinic acid (I), as represented by the formula 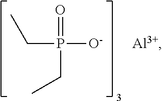
b) A tetraalkylpiperidine derivative selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines and 1-acyloxy-2,2,6,6-piperidines; and
c) A thermoplastic polymer substrate.

5. A composition according to claim 1, which comprises as Component b) at least one tetraalkylpiperidine derivative selected from the group that consists of 2,2,6,6-tetraalkylpiperidine-1-oxides of the formula 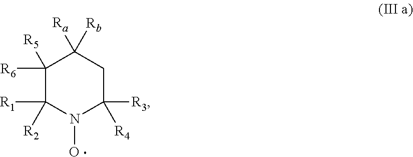
1-hydroxy-2,2,6,6-tetraalkylpiperidines of the formula 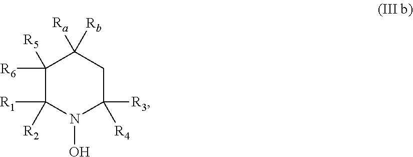
1-alkoxy-2,2,6,6-tetraalkylpiperidines of the formula 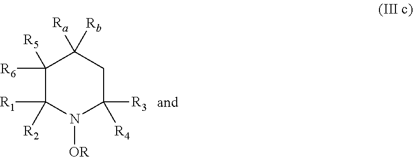
1-acyloxy-2,2,6,6-piperidines of the formula 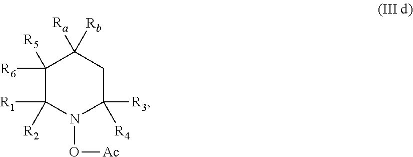
Wherein
One of Rₐ and R_{b} represents
Hydrogen or an N-substituent and the other one represents an O-substituent or a C-substituent; or
Both Rₐ and R_{b} represent hydrogen, O-substituents or C-substituents;
R represents C₁-C₂₀alkyl, C₅-C₆cycloalkyl or C₂-C₂₀alkyl, C₅-C₆cycloalkyl or C₂-C₂₀alkenyl with additional substituents;
Ac represents the acyl group of a C₁-C₂₀carboxylic acid; and
R₁-R₄ each represent C₁-C₄alkyl; and
R₅ and R₆, independently of one another, represent hydrogen or a substituent selected from the group consisting of C₁-C₄-alkyl, C₁-C₃alkylphenyl and phenyl; and
R₅ and R₆ together represent oxo.

6. A composition according to claim 5, which comprises as Component b) at least one tetraalkylpiperidine derivative III a, III b, III c or III d,
Wherein
One of Rₐ and R_{b} represents
Hydrogen or an N-substituent and the other one represents an O-substituent or a C-substituent; or
Both Rₐ and R_{b} represent hydrogen, O-substituents or C-substituents;
R represents C₁-C₈alkyl, C₅-C₆cycloalkyl or C₂-C₈alkyl, C₅-C₆cycloalkyl or C₂-C₈alkenyl with additional substituents;
Ac represents the acyl group of a C₁-C₈carboxylic acid; and
R₁-R₄ are each methyl; and
R₅ and R₆ each represent hydrogen.

7. A composition according to claim 5, which comprises as Component b) at least one tetraalkylpiperidine derivative III a, III b, III c or III d,
Wherein
One of Rₐ and R_{b} represents
Hydrogen or an N-substituent and the other one represents an O-substituent or a C-substituent; or
Both Rₐ and R_{b} represent O-substituents or C-substituents;
R represents C₁-C₈alkyl, C₅-C₆cycloalkyl or C₂-C₈alkyl, C₅-C₆cycloalkyl or C₂-C₈alkenyl substituted by hydroxy;
Ac represents the acyl group of a C₁-C₈carboxylic acid; and
R₁-R₄ are each methyl; and
R₅ and R₆ each represent hydrogen.

8. A composition according to claim 5, which comprises as Component b) at least one tetraalkylpiperidine derivative III c or III d selected from the group consisting of
1-Cyclohexyloxy-2,2,6,6-tetramethyl-4-octadecylaminopiperidine,
bis(1-Octyloxy-2,2,6,6-tetramethylpiperidin-4-yl)sebacate,
2,4-bis[(1-Cyclohexyloxy-2,2,6,6-tetramethylpiperidin-4-yl)butylamino]-6-(2-hydroxyethylamino-s-triazine,
bis(1-Cyclohexyloxy-2,2,6,6-tetramethylpiperidin-4-yl)adipate,
2,4-bis[(1-cyclohexyloxy-2,2,6,6-tetramethylpiperidin-4-yl)butylamino]-6-chloro-s-triazine,
1-(2-Hydroxy-2-methylpropoxy)-4-hydroxy-2,2,6,6-tetramethylpiperidine,
1-(2-Hydroxy-2-methylpropoxy)-4-oxo-2,2,6,6-tetramethylpiperidine,
1-(2-Hydroxy-2-methylpropoxy)-4-octadecanoyloxy-2,2,6,6-tetramethylpiperidine,
bis(1-(2-Hydroxy-2-methylpropoxy)-2,2,6,6-tetramethylpiperidin-4-yl)sebacate,
bis(1-(2-Hydroxy-2-methylpropoxy)-2,2,6,6-tetramethylpiperidin-4-yl)adipate,
2,4-bis{N-[1-(2-Hydroxy-2-methylpropoxy)-2,2,6,6-tetramethylpiperidin-4-yl]-N-butylamino}-6-(2-hydroxyethylamino)-s-triazine,
The reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine),
2,4-bis[(1-Cyclohexyloxy-2,2,6,6-tetramethylpiperidin-4-yl)butylamino]-6-(2-hydroxyethylamino-s-triazine,
The oligomeric compound which is the condensation product of 4,4′-hexamethylenebis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine,
The compound of the formula 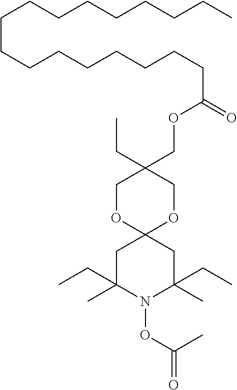
And the compound of the formula 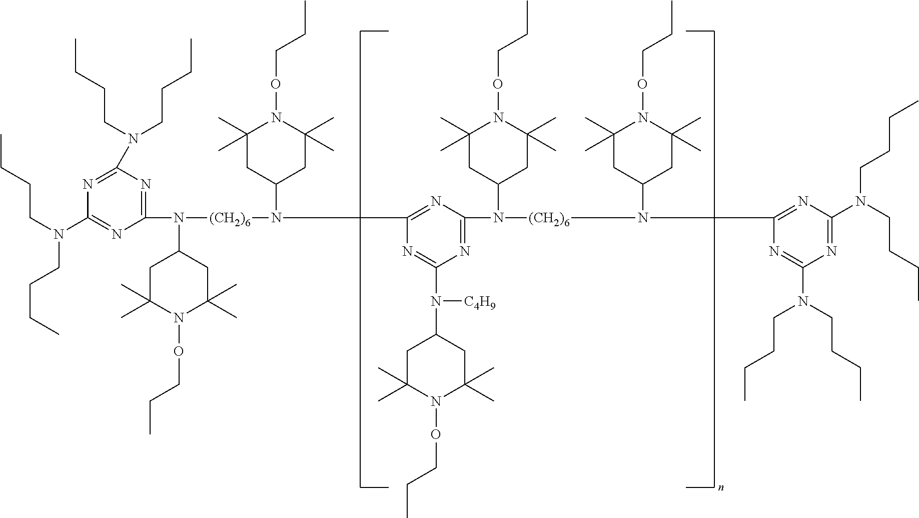
in which n is from 1 to 15.

9. A composition according to claim 1, which comprises
a) A salt of a phosphinic acid as represented by the structural formulae (I) or (II),
in which
one of R¹ and R² represents hydrogen or C₁-C₈alkyl; or both R¹ and R² represent C₁-C₈alkyl; and
R³ represents C₁-C₁₀alkylene, C₂-C₁₀alkylene interrupted by phenylene, phenylene, (C₁-C₄alkyl)₁₋₃phenylene, or phenyl-C₁-C₄alkylene;
b) At least one tetraalkylpiperidine derivative III c or III d selected from the group consisting of
1-Cyclohexyloxy-2,2,6,6-tetramethyl-4-octadecylaminopiperidine,
bis(1-Octyloxy-2,2,6,6-tetramethylpiperidin-4-yl)sebacate,
2,4-bis[(1-Cyclohexyloxy-2,2,6,6-tetramethylpiperidin-4-yl)butylamino]-6-(2-hydroxyethylamino-s-triazine,
bis(1-Cyclohexyloxy-2,2,6,6-tetramethylpiperidin-4-yl)adipate,
2,4-bis[(1-cyclohexyloxy-2,2,6,6-tetramethylpiperid in-4-yl)butylamino]-6-chloro-s-triazine,
1-(2-Hydroxy-2-methylpropoxy)-4-hydroxy-2,2,6,6-tetramethylpiperidine,
1-(2-Hydroxy-2-methylpropoxy)-4-oxo-2,2,6,6-tetramethylpiperidine,
1-(2-Hydroxy-2-methylpropoxy)-4-octadecanoyloxy-2,2,6,6-tetramethylpiperidine,
bis(1-(2-Hydroxy-2-methylpropoxy)-2,2,6,6-tetramethylpiperidin-4-yl)sebacate,
bis(1-(2-Hydroxy-2-methylpropoxy)-2,2,6,6-tetramethylpiperidin-4-yl)adipate,
2,4-bis{N-[1-(2-Hydroxy-2-methylpropoxy)-2,2,6,6-tetramethylpiperidin-4-yl]-N-butylamino}-6-(2-hydroxyethylamino)-s-triazine,
The reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine),
2,4-bis[(1-Cyclohexyloxy-2,2,6,6-tetramethylpiperidin-4-yl)butylamino]-6-(2-hydroxyethylamino-s-triazine,
The oligomeric compound which is the condensation product of 4,4′-hexamethylenebis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine,
The compound of the formula 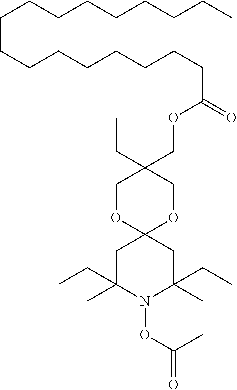
And the compound of the formula 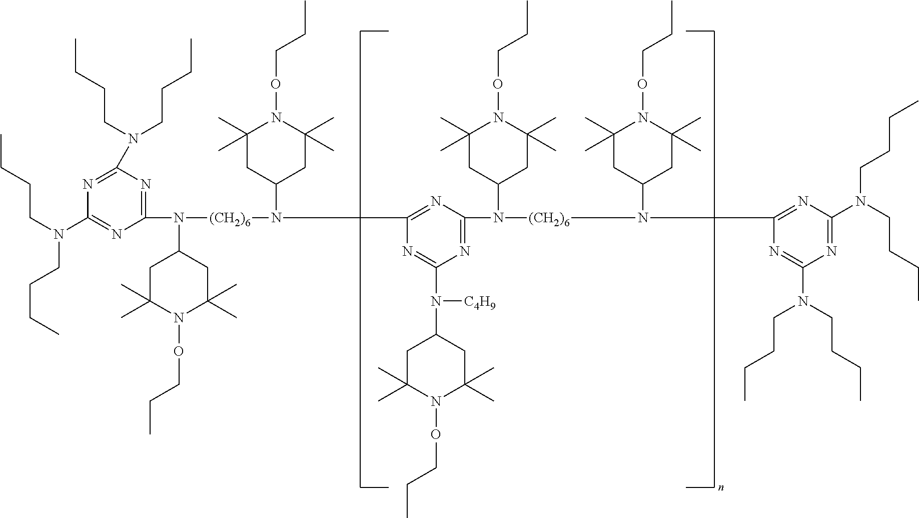
in which n is from 1 to 15; and
c) A thermoplastic polymer selected from the group consisting of polyolefin homopolymers and copolymers of olefins with each other or with vinyl monomers.

10. A composition according to claim 1 for use as a flame retardant.

11. A mixture, which comprises
a) A salt of a phosphinic acid as represented by the structural formulae 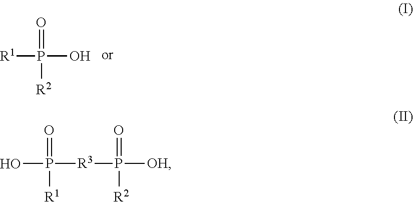
in which
one of R¹ and R² represents hydrogen or C₁-C₈alkyl; or both R¹ and R² represent C₁-C₈alkyl; and
R³ represents C₁-C₁₀alkylene, C₂-C₁₀alkylene interrupted by phenylene, phenylene, (C₁-C₄alkyl)₁₋₃phenylene, or phenyl-C₁-C₄alkylene;
b) A tetraalkylpiperidine derivative selected from the group that consists of 2,2,6,6-tetraalkylpiperidine-1-oxides, 1-hydroxy-2,2,6,6-tetraalkylpiperidines, 1-alkoxy-2,2,6,6-tetraalkylpiperidines and 1-acyloxy-2,2,6,6-piperidines.

12. A process for imparting flame retardancy to a polymer substrate, which process comprises adding to a polymer substrate of Component c) the mixture according to claim 1.
